(19) United States
(12) Patent Application Publication
(10) Pub. No.: US 2008/0089991 A1
(43) Pub. Date: Apr. 17, 2008

(54) Gelled dairy compositions and related methods

(76) Inventors: Julie A. Cox, Maple Grove, MN (US); Sid Kossowsky, Minneapolis, MN (US); Lisa K. Pannell, St. Louis Park, MN (US); Maeve C. Murphy, Plymouth, MN (US)

Correspondence Address: General Mills, Inc.;Number One General Mills Blvd., P.O. Box 1113, Minneapolis, MN, 55440, US

(21) Appl. No.: 11/581,765

(22) Filed: Oct. 16, 2006

(51) Int. Cl. A23L 1/05

(52) U.S. Cl. 426/573

(57) ABSTRACT

The present invention relates to hand-holdable, gelled dairy compositions, and related methods. The hand-holdable products include one or more gel-forming hydrocolloids in proper amount(s) that cause a dairy composition to gel under gelling conditions in a manner so as to provide a hand-holdable product.

### FIELD OF THE INVENTION

The present invention relates to gelled dairy compositions and related methods. More particularly, the present invention relates to gelled food products such as yogurt or pudding products that are hand-holdable and related methods.

### BACKGROUND

Dairy products are well known and include non-fermented dairy products (e.g., pudding) and fermented dairy products (e.g., yogurt).

Pudding is commonly known as a dessert-type food product that typically includes milk, sugar, and thickening agents. Pudding can be made by “instant” methods or methods that require cooking. For example, U.S. Pat. No. 4,623,552 (Rapp) discloses a method for making aseptically packaged pudding that has properties similar to homemade cooked-starch pudding. At retail, pudding products are typically packaged in small cup-style containers and have a creamy consistency such that they can be readily eaten with a spoon.

Yogurt is a nutritious popular fermented dairy product. At retail, a large number of yogurt products are available having a variety of fat content, sweetener type and level, flavor, and other attributes.

For example, U.S. Pat. No. 4,971,810 (Hoyda et al.) discloses fiber fortified yogurt products; U.S. Pat. No. 4,952,414 (Kaufman et al.) discloses yogurt with cereal pieces; U.S. Pat. No. 6,235,320 (Daravingas et al.) discloses multi-layered, colored yogurt products; U.S. Pat. No. 7,033,634 (Engesser et al.) discloses aerated or whipped yogurt products and describes that a hydrated emulsifier blend can be added to a cultured yogurt post fermentation; U.S. Pub. No. 2005/0255192 (Chaudhry et al.) discloses a method for making cultured dairy products with decreased fermentation times; and U.S. Patent Application titled “NOVEL AERATED MILK COMPOSITIONS,” filed Feb. 1, 2006, by Ketchmark et al., having Attorney Docket No. 6653US, and U.S. Ser. No. 11/324,550 discloses aerated milk compositions such as yogurt.

Many yogurt products are provided in small cups and are of a creamy consistency similar to pudding so that the yogurt can be readily eaten with a spoon. Some yogurt products are provided in the form of a drinkable product.

U.S. Pat. No. 6,537,603 (Kerrigan et al.) discloses a snack food product in the form of resilient, molded, self-sustaining bodies preferably made from a heated mixture including a dairy product (cheese, yogurt, or pudding), gelatin, fat, and water.

There is a continuing need to provide new and improved dairy products, especially having characteristics that are appealing to consumers.

### SUMMARY OF THE INVENTION

The present invention provides new and improved dairy products. In particular, the present invention provides dairy products that are gelled to a degree so as to be hand-holdable. Hand-holdable dairy compositions (e.g., yogurt, pudding, and the like) can be achieved by including one or more gel-forming hydrocolloid ingredient(s) in proper amount(s) that cause a dairy composition to gel under gelling conditions.

Advantageously, providing such a unique dairy product (i.e., hand-holdable) can allow dairy product(s) to be marketed to consumers in a particular way. For example, being able to handle and/or play with a hand-holdable dairy composition may make a particular dairy product more appealing to certain consumers. For example, some children may find a hand-holdable yogurt more appealing and may be more inclined to want to consume yogurt that is hand-holdable.

According to one aspect of the present invention, a hand-holdable, fermented gelled dairy composition includes a live and active culture and at least one gel-forming hydrocolloid ingredient. The hydrocolloid ingredient is present in an amount such that the gelled dairy composition has a Gel Strength Value of at least 100 grams.

According to another aspect of the present invention, a hand-holdable, gelled dairy composition includes at least one gel-forming hydrocolloid ingredient. The hydrocolloid ingredient is present in an amount such that the gelled dairy composition has a Gel Strength Value in the range of from 110 to 800 grams.

According to another aspect of the present invention, a hand-holdable, gelled dairy composition includes at least one gel-forming hydrocolloid ingredient and water. The at least one gel-forming hydrocolloid ingredient comprises gelatin that is present in an amount of at least 1.4 percent by weight based on the total weight of the hand-holdable, gelled dairy composition. The water is present in an amount in the range of from 65 to 85 percent by weight based on the total weight of the hand-holdable, gelled, dairy composition.

According to another aspect of the present invention, a hand-holdable, gelled dairy composition includes a non-dairy, gel-forming hydrocolloid component. The non-dairy, gel-forming hydrocolloid component includes a first, non-dairy, gel-forming hydrocolloid ingredient and a second, non-dairy, gel-forming hydrocolloid ingredient. The total amount of the first and second hydrocolloid ingredients is such that the gelled dairy composition has a Gel Strength Value of at least 100 grams.

According to another aspect of the present invention, a method of making a hand-holdable, gelled, fermented dairy composition includes the steps of providing a fermentable dairy base composition, fermenting the dairy base composition to provide a fermented dairy composition, and causing the fermented dairy composition to gel. The base composition includes at least one, non-dairy, gel-forming hydrocolloid ingredient. The temperature of the composition during fermentation is 125 degrees Fahrenheit or less. The fermented dairy composition is gelled in a manner to provide a hand-holdable, gelled, fermented dairy composition having a Gel Strength Value of at least 100 grams.

According to another aspect of the present invention, a method of making a hand-holdable, gelled, fermented dairy composition includes the steps of providing a fermentable dairy base composition, fermenting the dairy base composition to provide a fermented dairy composition, combining the fermented dairy composition with a non-dairy, gel-forming hydrocolloid component, and causing the fermented dairy composition to gel. The temperature of the composition during fermentation is 125 degrees Fahrenheit or less. The hydrocolloid component includes a first, non-dairy, gel-forming hydrocolloid ingredient and a second, non-dairy, gel-forming hydrocolloid ingredient. The fermented dairy composition is gelled in a manner to provide a hand-holdable, gelled, fermented dairy composition having a Gel Strength Value of at least 100 grams.

According to another aspect of the present invention, a method of making a hand-holdable, gelled dairy composition includes the step of causing the dairy composition to gel in a manner to provide a hand-holdable, gelled, dairy composition having a Gel Strength Value in the range of from 110 to 800 grams.

According to another aspect of the present invention, a method of formulating a hand-holdable, gelled dairy composition includes the step of selecting an amount of a first non-dairy, gel-forming hydrocolloid ingredient and a second non-dairy, gel-forming hydrocolloid ingredient based on information indicative of causing the dairy composition to gel so as to provide a hand-holdable composition.

In preferred embodiments, the dairy composition is a fermented dairy composition (e.g., yogurt).

### BRIEF DESCRIPTION OF THE DRAWINGS

FIG. 1A shows a plan view of a hand-holdable, gelled, yogurt composition according to the present invention.

FIG. 1B shows a perspective view of the hand-holdable yogurt product of FIG. 1A.

FIG. 2 shows a perspective view of the hand-holdable yogurt product of FIG. 1A in a package.

FIG. 3 shows a schematic flow diagram of a process for making a hand-holdable yogurt composition according to the present invention.

FIG. 4 shows a schematic flow diagram of an alternative process for making a hand-holdable yogurt composition according to the present invention.

### DETAILED DESCRIPTION

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

In general, dairy compositions are well known and can make up a wide variety of consumable food products or can be incorporated into a wide variety of consumable food products. While the present invention will be described in the specific context of yogurt compositions, the principles of the invention are applicable to other dairy compositions as well. Exemplary dairy compositions include cheese, yogurt, pudding, and the like.

As described herein, the term “yogurt” includes, but is not limited to, all of those food products meeting the definition as set forth in 21 C.F.R. Section 131.200, 131.203, and 131.206.

In general, a yogurt can be made from a fermentable dairy composition that includes a dairy base composition and a live and active culture. In addition, a fermentable dairy composition according to the present invention includes a gel-forming hydrocolloid component and, optionally, one or more additives.

Dairy base composition(s) for making a yogurt are well known and are described in, e.g., U.S. Pat. No. 4,971,810 (Hoyda et al.); U.S. Pat. No. 5,820,903 (Fleury et al.); U.S. Pat. No. 6,235,320 (Daravingas et al.); U.S. Pat. No. 6,399,122 (Vandeweghe et al.); U.S. Pat. No. 6,740,344 (Murphy et al.); and U.S. Pub. No. 2005/0255192 (Chaudhry et al.). In general, a dairy base composition includes at least one fermentable dairy ingredient. A fermentable dairy ingredient can include raw milk or a combination of whole milk, skim milk, condensed milk, dry milk (for example, dry milk solids non-fat, or MSNF), grade A whey, cream, and/or such other milk fraction ingredients as buttermilk, whey, lactose, lactalbumins, lactoglobulins, or whey modified by partial or complete removal of lactose and/or minerals, and/or other dairy ingredients to increase the nonfat solids content, which are blended to provide the desired fat and solids content. If desired, the dairy base can include a filled milk component, such as a milk ingredient having a portion supplied by a non-milk ingredient (for example, oil or soybean milk).

Preferably, the fermentable dairy ingredient is composed of bovine milk. However, other milks can be use as a partial or whole substitute for bovine milk, such as camel, goat, sheep or equine milk. In some embodiments, the dairy base can comprise a vegetable milk such as soymilk.

In general, it is well-known to typically formulate a dairy base composition to have a milk solids content and a fat content. In exemplary embodiments, a dairy base composition has a milk solids content in the range of from 6 to 24 weight percent, preferably from 7 to 10 weight percent, and even more preferably about 9 weight percent based on the total weight of the dairy base composition. In exemplary embodiments, a dairy base composition has a fat content in the range of from 0 to 12 weight percent based on the total weight of the dairy base composition. With respect to exemplary embodiments of the final product (i.e., a hand-holdable composition) the fat content is in the range of from 0.5 to 10 weight percent, preferably from 0.5 to 5 weight percent, from 0.5 to 3 weight percent, and even more preferably about 2 weight percent based on the total weight of the hand-holdable, gelled, dairy composition.

In addition, dairy base composition(s) typically include sugar ingredient(s), flavor ingredient(s), process viscosity modifier(s), vitamin(s), combinations of these, and the like (additives are further discussed below).

In preferred embodiments, sugar is present in an amount of from 0 to 20 weight percent, preferably 12 to 17 weight percent based on the total weight of the dairy base composition.

In preferred embodiments, a process viscosity modifier can be present in an amount of from 0.5 to 3 weight percent, preferably 1 to 2 weight percent based on the total weight of the dairy base composition. An exemplary process viscosity modifier can be commercially obtained from National Starch (Bridgewater, N.J.) under the tradename THERMTEX®.

Any live and active culture useful in making fermented dairy products for consumption can be used with a dairy base composition. Such live and active culture(s) are well known. An exemplary live and active culture can include any microorganism suitable for lactic fermentation such as Lactobacillus sp., Streptococcus sp., combinations of these, and the like. More specifically, a live and active culture can include Lactobacillus bulgaricus, Streptococcus thermophilus, Lactobacillus lactis, Lactobacillus casei, Lactobacillus acidophilus, Bifidobacterium lactis, Bifodobacterium bifidus, Lactococcus cremoris, Lactococcus lactis, Lactococcus lactis ss diacetyllactis, combinations of these, and the like.

As used herein, the term “gel-forming hydrocolloid ingredient” refers to an ingredient that disperses well in water, but due to its relatively large molecular size it is not readily soluble in water and therefore the resulting physical conformation in water is colloidal. In addition, a gel-forming hydrocolloid ingredient causes a food composition to gel to a certain degree when the gel-forming hydrocolloid ingredient is present in a given gel-forming amount and the food composition is subjected to gelling conditions. Typical gelling conditions include subjecting a dairy composition according to the present invention to a temperature in the range of from 35 to 70 degrees Fahrenheit, preferably from 35 to 55 degrees Fahrenheit, and even more preferably from 35 to 45 degrees Fahrenheit for a time period of 0 to 12 hours. Most of the gelation will occur within 12 hours, but maximum gel set could occur after 48 hours.

In contrast to a gel-forming hydrocolloid ingredient, some hydrocolloid ingredients can be used as rheology modifiers in the processing of dairy compositions such as yogurt but such hydrocolloid ingredients may not cause such a composition to gel when exposed to gelling conditions.

In general, gel-forming hydrocolloids are well known. A gel-forming hydrocolloid ingredient is typically a polysaccharide or protein. Preferred gel-forming ingredient(s) include non-dairy, gel-forming hydrocolloid ingredient(s).

As used herein, a non-dairy, gel-forming hydrocolloid ingredient is a gel-forming hydrocolloid ingredient that is distinguishable from a dairy, gel-forming hydrocolloid. As used herein, a dairy, gel-forming hydrocolloid ingredient refers to some materials naturally found in milk that can cause a dairy composition to gel under proper conditions. For example, milk can include casein protein and/or whey protein. Such proteins can contribute to a slight gel formation of a dairy composition when exposed to proper conditions such as pH, ion concentration, temperature, combinations of these, and the like. For example, acid produced during fermentation can cause casein protein micelle dissociation and aggregation. During heating, whey protein can be denatured, becoming insoluble and tending to cause gelation. Heat denatured whey proteins can also interact with κ-caseins for further gelation in some dairy products. Such milk proteins can be classified as dairy gel-forming hydrocolloids.

An exemplary non-dairy, gel-forming hydrocolloid ingredient for use in a dairy composition of the present invention can include gelatin, agar, alginate, carrageenan, pectin, starch, xanthan/locust bean gum blend, gellan gum, konjac gum, combinations of these, and the like. It is noted that some gel-forming hydrocolloid ingredients (e.g., starch) can have structural modifications that can influence the gel-forming ability of the hydrocolloid.

One or more gel-forming hydrocolloid ingredients can be selected in proper amounts so as to cause a dairy composition to gel under gelling conditions in a manner that provides a gelled dairy composition that is hand-holdable. A hand-holdable dairy composition has a firmness such that it can be held in a consumer's hands for a variety of purposes such as to consume, to play with, combinations of these, and the like. In preferred embodiments, a hand-holdable dairy composition according to the present invention is soft and springy such that the composition does not deform to an undue degree when pressure is applied from a consumer's hands.

Providing a dairy composition such as yogurt that is hand-holdable can be highly advantageous in that it can allow a consumer market such as children to be provided with a food product that they might not otherwise find desirable. As discussed below, a hand-holdable yogurt can be shaped into a form appealing to children and the children can even find a certain play value in the hand-holdable shape, thereby making the yogurt product even more desirable.

The amount of a hydrocolloid ingredient used in a dairy composition to help provide a hand-holdable composition can depend on the particular hydrocolloid ingredient selected.

The gelation potential of gelatin is typically reported as a Bloom number (units of grams), which refers to the force required to compress a standardized gelatin composition. A Bloom number of a standardized gelatin and methods of determining such a Bloom number are well known. See, e.g., U.S. Pat. No. 1,540,979. Commercial gelatins typically range from a low Bloom (<150 grams) through a medium Bloom (150-220 grams) to a high Bloom (>220 grams). Commercial gelatins are typically sourced from pork, beef, or fish (piscine). Preferred sources of gelatin include beef sources so as to allow for Kosher Dairy certification. A preferred gelatin obtained from a beef source includes type B, edible grade gelatin derived from the alkaline hydrolysis of collagen in selected beef hide trimmings (acid hydrolysis of collagen yield type A gelatins). Preferably, a gelatin has a Bloom value in the range of from 230-250 grams. Such gelatin can be commercially obtained from PB Leiner, Jericho, N.Y.; Kraft Foods Atlantic, Woburn, Mass.; and Gelita USA, Inc., Sioux City, Iowa.

Exemplary embodiments of a hand-holdable, gelled dairy composition according to the present invention can include gelatin as a gel-forming hydrocolloid and in an amount of at least 1.4 percent by weight based on the total weight of the gelled dairy composition. Preferably, the gelatin is present in an amount of at least 1.5 percent, at least 1.6 percent, at least 1.7 percent, at least 1.75 percent, at least 1.8 percent, at least 1.9 percent, at least 2.0 percent, and even more preferably at least 2.1 percent by weight based on the total weight of the gelled dairy composition. Preferably, the gelatin is present in an amount in the range of from 1.5 to 10 percent, 1.75 to 10 percent, 1.75 to 4 percent, 2 to 5 percent, and even more preferably in the range of from 2 to 3.5 percent by weight based on the total weight of the gelled dairy composition.

Pectins are primarily polymers of polygalacturonic acid, which can be esterified to varying degrees. Pectins can be processed to yield high and low methoxyl pectins. High methoxyl pectins can form gel networks at acidic pHs in the presence of high soluble solids. Low methoxyl pectins tend to be less dependent on pH and soluble solids than high methoxyl pectins, but do utilize calcium for gelation. Exemplary dairy compositions according to the present invention include calcium and are low in soluble solids and can use low methoxyl pectins as gel-forming hydrocolloid ingredient(s). A preferred, commercially available pectin includes a low ester pectin obtained from CP Kelco, Chicago, Ill., under the tradename LM 18 CG YA.

Exemplary embodiments of a hand-holdable, gelled dairy composition according to the present invention can include pectin as a gel-forming hydrocolloid ingredient and in an amount of at least 0.10 percent by weight based on the total weight of the gelled dairy composition. Preferably, the pectin is present in an amount of at least 0.22 percent by weight based on the total weight of the gelled dairy composition. Preferably, the pectin is present in an amount in the range of from 0.10-0.5 percent by weight, and even more preferably in the range of from 0.2-0.4 percent by weight based on the total weight of the gelled dairy composition.

In general, gellan gums are available in two types, high and low acyl gellan. High acyl gellan gums tend to form relatively soft and very elastic gels. Low acyl gellan gums tend to form gels that are relatively non-elastic and brittle. A preferred, commercially available gellan gum can be obtained from CP Kelco, Chicago, Ill., under the tradename Kelcogel® F.

Exemplary embodiments of a hand-holdable, gelled dairy composition according to the present invention can include gellan gum as a gel-forming hydrocolloid ingredient and in an amount of at least 0.04 percent by weight based on the total weight of the gelled dairy composition. Preferably, the gellan gum is present in an amount of at least 0.13 percent by weight based on the total weight of the gelled dairy composition. Preferably, the gellan gum is present in an amount in the range of from 0.04-0.4 percent by weight and even more preferably in the range of from 0.13-0.3 percent by weight based on the total weight of the gelled dairy composition.

Exemplary embodiments of a hand-holdable, gelled dairy composition according to the present invention can include alginate as a gel-forming hydrocolloid ingredient and in an amount of at least 0.4 percent by weight based on the total weight of the gelled dairy composition. Preferably, the alginate is present in an amount of at least 0.7 percent by weight based on the total weight of the gelled dairy composition. Preferably, the alginate is present in an amount in the range of from 0.4-1.25 percent by weight and even more preferably in the range of from 0.6-0.9 percent by weight based on the total weight of the gelled dairy composition.

Exemplary embodiments of a hand-holdable, gelled dairy composition according to the present invention can include agar as a gel-forming hydrocolloid ingredient and in an amount of at least 0.1 percent by weight based on the total weight of the gelled dairy composition. Preferably, the agar is present in an amount of at least 0.3 percent by weight based on the total weight of the gelled dairy composition. Preferably, the agar is present in an amount in the range of from 0.2-0.6 percent by weight based on the total weight of the gelled dairy composition.

Some gel-forming hydrocolloid ingredients may be further classified as an elastic, gel-forming hydrocolloid or a brittle, gel-forming hydrocolloid. A brittle, gel-forming hydrocolloid ingredient can cause a gelled dairy composition to fracture or collapse more readily during eating than an elastic, gel-forming hydrocolloid ingredient. A brittle, gel-forming hydrocolloid ingredient can be identified by having a particular Brittleness value according to the TPA method (described below). The Brittleness value of a brittle, gel-forming hydrocolloid typically depends on one or more of percent solids of the gelled dairy composition, percent of the brittle hydrocolloid in the gelled dairy composition, combinations of these, and the like. Examples of a brittle hydrocolloid ingredients include agar, high guluronic acid alginate, kappa carrageenan, low acyl gellan gum, and pectin, starch, combinations of these, and the like.

Elastic, gel-forming hydrocolloid ingredients can cause a gelled dairy composition to be more springy and rubbery during eating than a brittle, gel-forming hydrocolloid ingredient. An elastic, gel-forming hydrocolloid ingredient can be identified by having a particular Springiness value according to the TPA method (described below). The Springiness value of an elastic, gel-forming hydrocolloid typically depends on one or more of percent solids of the gelled dairy composition, percent of the elastic hydrocolloid in the gelled dairy composition, combinations of these, and the like. Examples of an elastic hydrocolloid ingredient include gelatin, high mannuronic acid alginate, iota carrageenan, high acyl gellan, combinations of these, and the like.

One or more brittle, gel-forming hydrocolloid ingredients can be combined with one or more elastic, gel-forming hydrocolloid ingredients so as to provide a gelled dairy composition according to the present invention.

One or more gel-forming hydrocolloid ingredients can be selected and provided in amount(s) so that a gelled dairy composition has a Gel Strength value corresponding to a hand-holdable composition. In preferred embodiments, a hand-holdable, gelled dairy composition has a Gel Strength Value of at least 100 grams, more preferably at least 110 grams, at least 115 grams, at least 120 grams, at least 125 grams, or even more preferably at least 125 grams. In general, a hand-holdable dairy composition such as yogurt can have a Gel Strength Value as high as desired. In exemplary embodiments, a gelled dairy composition has a Gel Strength Value in the range of from 100 to 500 grams, more preferably in the range of from 110 to 800 grams, 110 to 500 grams, 115 to 375 grams, 120 to 350 grams, 130 to 300 grams, 150 to 250 grams, or even more preferably in the range of from 170 to 220 grams.

The Gel Strength Value of a gelled dairy composition (e.g., yogurt) can be determined by following the methodology described in Association of Official Analytical Chemists (AOAC) Official Method 948.21 and titled “Jelly Strength of Gelatin” (Official Methods of Analysis of AOAC International, 16^{th} Ed. Vol. II). Instruments for following (AOAC) Official Method 948.21 are well known. A commercially available testing instrument for determining the Gel Strength Value of a gelled dairy composition according to the present invention can be obtained from Stable Micro Systems, Surrey, UK, having model number TA-HD PLUS. To determine the Gel Strength Value of a test sample, a test sample is prepared by providing a dairy composition according to the present invention in a 6 ounce polypropylene cup and allowing the dairy composition to gel for a minimum of 48 hours at temperature of about 40 degrees Fahrenheit. The surface diameter of the gelled dairy composition is about 65 millimeters. The TA-HD PLUS uses a probe to determine the force required for the probe to penetrate 4 millimeters into the gelled dairy composition. Such force is reported in units of grams. The probe has a diameter 12.7 millimeters in diameter. The more firm that a gelled dairy composition is, more force that will be needed to penetrate the composition 4 millimeters and, therefore, the higher the Gel Strength Value will be. This method is also discussed in “Food Texture: Measurement and Perception,” Andrew J. Rosenthal, Aspen Publishers, Inc. 1999.

In addition to Gel Strength Value, one or more additional parameters may be determined to characterize a hand-holdable composition of the present invention. For example, a hand-holdable composition according to the present invention can be formulated to target one or more desirable parameters of a Texture Profile Analysis (TPA). A TPA can determine a variety of parameters for a gelled dairy composition that correspond to desirable eating characteristics such as mouth feel, chewability, combinations of these, and the like. A TPA measures a variety of parameters such as Hardness, Fracturability (Brittleness), Cohesiveness, Adhesiveness, Springiness, Chewiness, and Gumminess. These parameters can be determined from a TPA graph, which graphs force versus time for multiple compressions of food material using a TPA measuring instrument. A Hardness value correlates to the force required to compress a food material between molars and is determined from a TPA graph as the height of the force peak on the first compression cycle. A Brittleness value correlates to the force at which a food material fractures and is determined from a TPA graph as the force of the significant break in the curve on the first compression cycle. A Cohesiveness value correlates to the strength of the internal bonds of the food material and is determined from a TPA graph as the ratio of force areas under the first and second compression cycles. An Adhesiveness value correlates to the work required to retract the plunger instrument from a food material after compression and can be determined from a TPA graph as the negative force area of the first compression. A Springiness value correlates to the extent to which a compressed food returns to its original size when the load is removed and can be determined from a TPA graph as the distance the food recovers its height during the time that elapses between the first and second bites. A Gumminess value correlates to the energy required to disintegrate a semisolid food so that it is ready for swallowing and can be determined as the product of the Hardness valued and the Cohesiveness value (Hardness×Cohesiveness). A Chewiness value correlates to the energy required to chew a solid food until it is ready for swallowing and can be determined as the product of the Gumminess value and the Springiness value (Gumminess×Springiness).

In preferred embodiments, a gelled dairy composition has a Hardness value in the range of from 1.5 to 5 kilograms, preferably from 2.0 to 4.0 kilograms, from 2.1 to 2.5 kilograms, and even more preferably from 2.2-2.3 kilograms.

One or more TPA parameters can be determined by preparing a sample, bite size piece of gelled dairy composition that is 2 centimeters in height and is equilibrated to a temperature of about 40 degrees Fahrenheit. In making the test sample, the test sample is subjected to gelling conditions for at least 48 hours prior to testing so that the gel can set properly. The food sample is tested using a commercially available testing machine from Stable Micro Systems, Surrey, UK, having model number TA-HD PLUS. The bite size sample is placed in the testing machine and compressed two times in a reciprocating motion. Each compression cycle compresses the food sample 15 millimeters, which corresponds to 75 percent deformation. A force vs. time graph (TPA graph) is generated and yields the parameters discussed above. Such parameters correlate well with actual sensory response of a consumer.

TPA parameters and methodology for determining such parameters are discussed in e.g., “Food Texture: Measurement and Perception,” Andrew J. Rosenthal, Aspen Publishers, Inc. 1999; and “Food Texture and Viscosity: Concept and Measurement,” Malcolm C. Bourne, Academic Press 1982.

In addition to TPA parameters, another parameter that can be used to characterize a hand-holdable composition according to the present invention includes water content. In preferred embodiments, such a hand-holdable dairy composition has relatively low surface moisture and water does not release from cut or torn surfaces of the composition. Preferably, the water content of a hand-holdable composition according to the present invention is in an amount of at least 65 percent by weight based on the total weight of the gelled dairy composition. Preferably, the water content is present in an amount in the range of from 65 to 85 percent by weight, 70 to 80 percent by weight, and even more preferably in the range of from 70 to 75 percent by weight based on the total weight of the gelled dairy composition.

In preferred embodiments, a hand-holdable dairy composition is also formulated such that the gelled composition has suitable release properties from a mold, packaging material, combinations of these, and the like.

In addition to the final food product characteristics discussed above, selecting one or more gel-forming hydrocolloid ingredients and their amounts can also be based on process considerations depending on how the gelled dairy composition is made. For example, gel-forming hydrocolloid(s) can influence composition viscosity during processing depending on factors such as composition temperature, water content, combinations of these, and the like. With respect to making gelled dairy compositions according to the present invention such as yogurt, it is generally desirable to minimize viscosity during homogenization, pasteurization, and fermentation of the dairy base composition, yet have a suitable (typically relatively higher) viscosity for filling molds and/or packaging material with the dairy composition.

Optionally, a dairy composition for use according to the present invention can include one or more additives to enhance process characteristics, product characteristics, combinations of these, and the like. Exemplary additives include flavoring(s) (e.g., fruit puree(s), fruit particulate(s), nut particulate(s), combinations of these, and the like), coloring(s), acidulant(s), process viscosity modifier(s) (e.g., hydrocolloid(s) such as certain starch(es) and the like), sweetener(s), sequestrant(s), preservative(s) (e.g., mold inhibitor(s) and/or yeast inhibitor(s)), emulsifier(s), vitamin(s), combinations of these and the like.

As described above, a gelled dairy composition according to the present invention can include a hydrocolloid component that includes gel-forming ingredient(s) and other hydrocolloid ingredient(s) (e.g., viscosity modifiers and the like). Accordingly, a hydrocolloid component used in a process for making a gelled dairy composition according to the present invention is preferably selected such that 1) viscosity during any homogenization and/or pasteurization is minimized, 2) a desirable filling viscosity is achieved (discussed below), 3) the gelled composition has desirable Gel Strength Value and TPA Hardness (discussed above), and 4) the gelled composition has suitable release characteristics (from a mold, packaging, combinations of these, and the like). In addition, with respect to processing considerations of a gelled, fermented dairy composition, depending on the particular gel-forming hydrocolloid ingredient(s)/amount(s) selected and the process of making, gel-forming hydrocolloid ingredient(s) can be added before, after, or both before and after the dairy composition is fermented. Also, if one or more gel-forming hydrocolloid ingredient(s) are combined with the dairy composition pre-fermentation, such ingredient(s) are preferably selected to minimize viscosity during fermentation.

A gelled dairy composition according to the present invention can be in any desirable product form. In preferred embodiments, a gelled dairy composition according to the present invention is in the form of three-dimensional shape having one or more sides that have a particular form appealing to a consumer. For example, a shaped composition could be in the form of an animal, a cartoon character, a person, combinations of these, and the like. Such shapes could be selected to be particularly appealing to children. In addition, other desirable shapes include a bar form (e.g., similar to a candy bar or energy bar), a cylinder form (e.g., similar to string cheese), a tape-like form (e.g., so that the gelled composition could be rolled up), combinations of these and the like.

In addition, a gelled dairy composition according to the present invention could have multiple textures, colors, be combined and/or layered with other compositions having similar or different textures and colors, combinations of these, and the like.

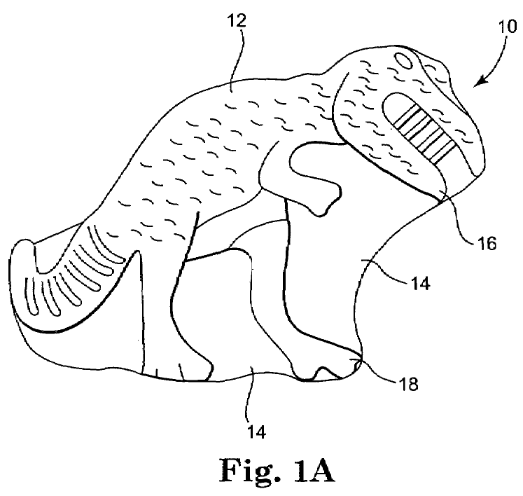

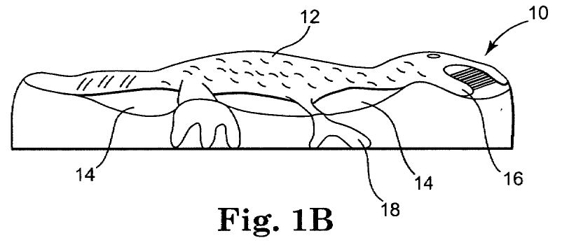

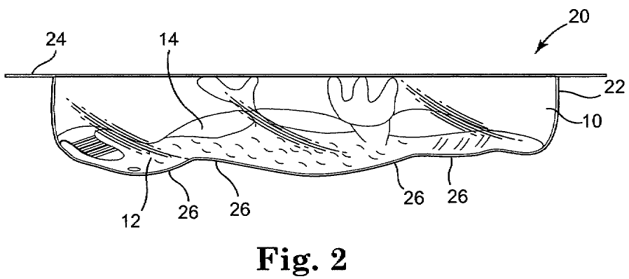

An exemplary hand-holdable, gelled, yogurt product 10 is shown in FIGS. 1-2. As shown in FIGS. 1A-1B, product 10 includes a portion 12 that includes contours so as to form a dinosaur and flat portions 14 that fill space between features of portion 12. For example, a portion 14 can fill the space between jaw 16 and foot 18 of portion 12.

A gelled dairy composition according to the present invention can be packaged in any suitable packaging. Such packaging can include packaging suitable for storage, distribution, consumer handling, refrigeration conditions, combinations of these, and the like. Exemplary packaging material includes film packaging (e.g., transparent and/or non-transparent) materials, molded packaging materials, combinations of these, and the like. The packaging materials can have a shape that includes a cup, tube, a shape for molding a dairy composition, combinations of these, and the like.

An exemplary packaged, hand-holdable dairy product is shown in FIG. 2. As shown in FIG. 2, the packaged, hand-holdable yogurt 20 includes transparent film portions 22 and 24. Portion 22 includes portions 26 that conform to and are in contact with portions 14 and the contours of portion 12.

Packaging materials such as film portions 22 and 24 can include one or more release agents to facilitate release of the hand-holdable yogurt product 10 from film portions 22 and 24, especially the portions 26 that function as a mold to form portions 12 and 14. Release agents for use with food products are well-known. Exemplary release agents for use food products include glycerol monostearate, silicone-based materials, combinations of these, and the like.

In general, a gelled dairy composition according to the present invention can be made by combining one or more gel-forming hydrocolloids in proper amount(s) with a dairy composition. Such method(s) according to the present invention can be adapted to any method for making dairy compositions such as yogurt or pudding. However, as mentioned above, gel-forming hydrocolloids used to make a hand-holdable composition according to the present invention can impact the viscosity of the dairy composition during processing. Accordingly, depending on which gel-forming hydrocolloid ingredient(s)/amount(s) are selected can impact when the gel-forming hydrocolloid(s) are combined with the dairy composition. In preferred embodiments, a method according to the present invention coordinates the step of combining the gel-forming hydrocolloid ingredient(s) with the dairy composition based on the particular one or more gel-forming hydrocolloid ingredient(s) that are selected and the amount(s) the hydrocolloids are selected in so as to prevent undue fouling of process equipment and/or conditions.

Methods for making yogurt compositions, including equipment and process steps, are well-known. See, e.g., U.S. Pat. No. 4,971,810 (Hoyda et al.); U.S. Pat. No. 5,820,903 (Fleury et al.); U.S. Pat. No. 6,235,320 (Daravingas et al.); U.S. Pat. No. 6,399,122 (Vandeweghe et al.); U.S. Pat. No. 6,740,344 (Murphy et al.); and U.S. Pub. No. 2005/0255192 (Chaudhry et al.). Preferred yogurt making methodology includes processes for making stirred-style yogurt (see, e.g., U.S. Pat. No. 7,033,634 (Engesser et al.)).

Methods for making pudding compositions, including equipment and process steps, are well-known. See, e.g., U.S. Pat. No. 4,623,552 (Rapp).

See also U.S. Pat. No. 6,596,334 (Flickinger et al.) as a useful technique for hydrating hydrocolloid ingredient(s) in processing a food composition.

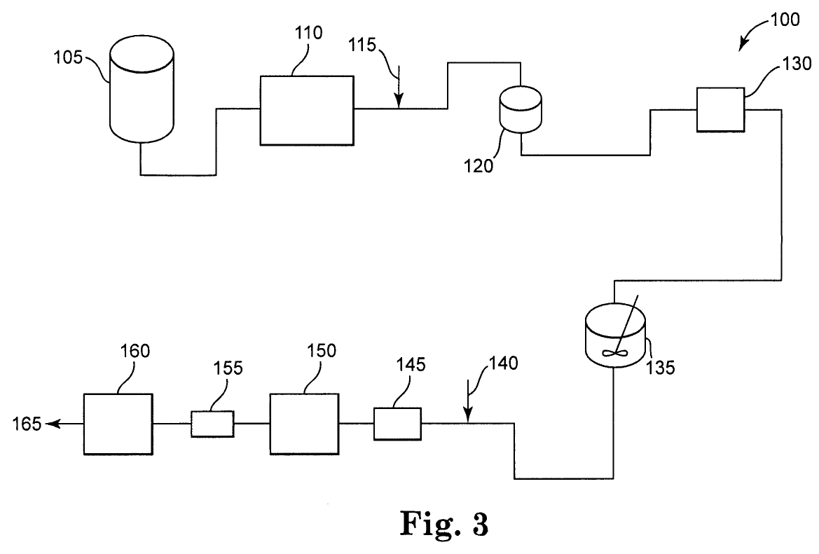

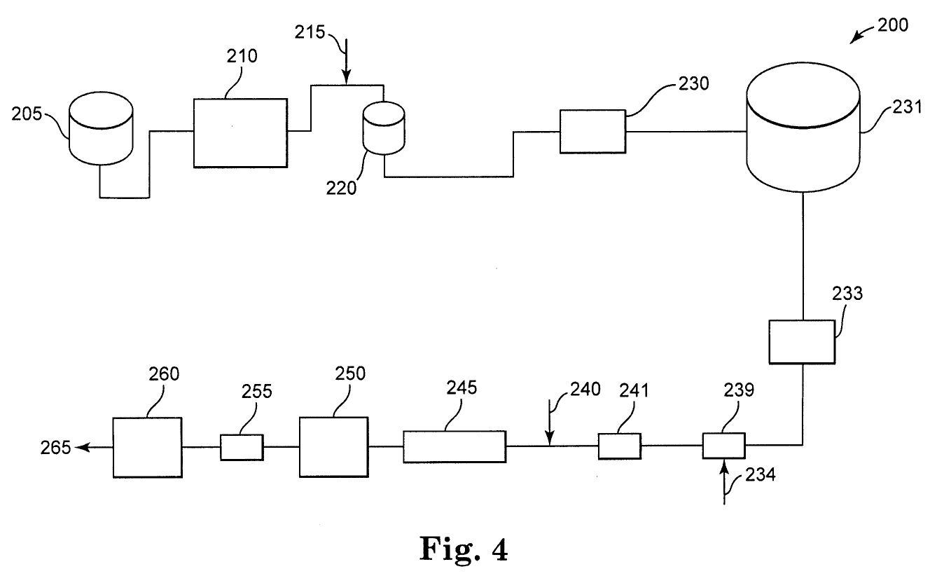

FIGS. 3 and 4 are each schematic flow diagrams that illustrate two exemplary methods for making a hand-holdable yogurt according to the present invention.

As shown in FIG. 3, method 100 includes batch mixer 105 where a dairy base composition is combined with at least one gel-forming hydrocolloid in an amount to provide a gelled, fermented dairy composition having a Gel Strength Value of at least 100 grams. Optionally, one or more additives for making a yogurt product can be added in batch mixer 105 (e.g., sugar ingredient(s), flavor ingredient(s), process viscosity modifier(s), vitamin(s), combinations of these, and the like). After proper mixing at mixer 105, the dairy base composition, including the gel-forming hydrocolloid component, is subjected to homogenization and pasteurization at process step 110.

After homogenization and pasteurization at step 110, a live and active culture is added to the dairy base composition at step 115 so that the dairy base can be fermented in fermentation tank 120. Fermentation is typically performed at a temperature in the range of from 90 to 125 degrees Fahrenheit, preferably in the range of from 110 to 115 degrees Fahrenheit. Preferably, at least from during the fermentation step 115 to the end of the step of causing the fermented composition to gel 150 (see below), the fermented composition is not exposed to a temperature greater than 125 degrees Fahrenheit. In general, exposing the fermented composition to a temperature greater than 125 degrees Fahrenheit can harm the live and active culture to an undue degree.

In general, during homogenization/pasteurization 110 and fermentation 120, it is desirable for the composition to have a viscosity such that the composition flows well and is easy to pump.

After fermentation, the fermented dairy composition is cooled as indicated by step 130 in a manner so as to hinder the live and active culture from undue activity after fermentation yet prevent undue fouling and/or viscosity build-up due to the presence of, e.g., the gel-forming hydrocolloid component. The fermented dairy composition is typically cooled to a temperature in the range of 65 to 90 degrees Fahrenheit, preferably a temperature of about 70 degrees Fahrenheit. The cooled, fermented dairy composition can be stored in agitated tank 135 for a time period of up to about 72 hours, but preferably less than 24 hours.

After storage and just prior to filling one or more containers at step 145, optional additives (coloring, flavoring, acidulants, combinations of these, and the like) can be added at step 140.

Preferably, the viscosity of the fermented dairy composition has a viscosity during filling step 145 such that the composition is fluid enough to displace the air in a container (e.g., portion 22 in FIG. 2) in a manner that causes the composition to be in contact with a desirable interior surface of the container. For example, referring to FIG. 2, it is preferred that the composition is in contact with the portions 26 which also function as a mold so as to shape the composition for forming a gelled composition 10 that has shaped portions 12 and 14 that correspond to the mold portions 26. In exemplary embodiments, during at least a portion of the filling step 145 the composition has a Brookfield Viscosity Value in the range of from 1000 centipoise to 17,000 centipoise, from 1500 centipoise to 15,000 centipoise, even more preferably from 2000 centipoise to 10,000 centipoise, and even more preferably a viscosity of about 7,500 centipoise at a temperature in the range of from 65 to 90 degrees Fahrenheit, preferably from 70 to 90 degrees Fahrenheit, even more preferably from 70 to 80 degrees Fahrenheit. As used herein, a Brookfield Viscosity Value refers to a viscosity as measured by using a Brookfield Viscometer having model number RVDVII+ with spindle #5 and at 10 rpm. A Brookfield Viscometer can be obtained from Brookfield Engineering Laboratories, Stoughton, Mass.

After filling at step 145, the filled containers can be cooled at step 150 to help cause the fermented dairy composition to gel in manner so as to provide a hand-holdable yogurt composition according to the present invention. In preferred embodiments, the composition is cooled to about 45 degrees Fahrenheit or less, preferably to a temperature in the range of from 35 to 45 degrees Fahrenheit. The composition typically gels completely within about 48 hours depending on the particular cooling conditions.

After cooling/gelling step 150, the hand-holdable yogurt products can be packaged at step 155 (e.g., for shipping purposes), palletized at step 160, and sent to distribution centers at step 165 for distribution to, e.g., grocery stores for purchase by consumers.

The method illustrated in FIG. 4 includes many similar process steps, including many similar process conditions/parameters as that illustrated in FIG. 3. In general, one difference between the method illustrated in each of FIGS. 3 and 4 is when the hydrocolloid component is combined with the dairy composition.

As shown in FIG. 4, method 200 includes batch mixer 205 where a dairy base composition is formed. Optionally, one or more additives for making a yogurt product can be added in batch mixer 205 (e.g., sugar ingredient(s), flavor ingredient(s), process viscosity modifier(s), vitamin(s), combinations of these, and the like). It is noted that unlike mixer 105 in the method in FIG. 3, a gel-forming hydrocolloid ingredient is not combined with the dairy base composition in mixer 205.

However, as an alternative, one or more gel-forming hydrocolloid ingredients could be introduced in mixer 205 (depending on type and amount of such ingredients) and introduced via stream 234 (discussed below). For example, a relatively small amount of one or more gel-forming hydrocolloid ingredient(s) could be added in mixer 205 and a relatively larger amount of one or more gel-forming hydrocolloid ingredient(s) could be added post-fermentation (e.g., via stream 234).

After proper mixing at mixer 205, the dairy base composition is subjected to homogenization and pasteurization at process step 210.

After homogenization and pasteurization at step 210, a live and active culture is added to the dairy base composition at step 215 so that the dairy base can be fermented in fermentation tank 220. Fermentation is typically performed at a temperature in the range of from 90 to 125 degrees Fahrenheit, preferably in the range of from 110 to 115 degrees Fahrenheit. Preferably, at least from during the fermentation step 215 to the end of the step of causing the fermented composition to gel 250 (see below), the fermented composition is not exposed to a temperature greater than 125 degrees Fahrenheit. In general, exposing the fermented composition to a temperature greater than 125 degrees Fahrenheit can harm the live and active culture to an undue degree.

In general, during homogenization/pasteurization 210 and fermentation 220, it is desirable for the composition to have a viscosity such that the composition flows well and is easy to pump.

After fermentation, the fermented dairy composition is cooled as indicated by step 230 in a manner so as to hinder the live and active culture from undue activity after fermentation yet prevent undue fouling and/or viscosity build-up due to the presence of, e.g., viscosity modifying hydrocolloid ingredient(s). The fermented dairy composition can be cooled to a temperature of less than 90 degrees Fahrenheit, preferably to a temperature in the range from 35 to 90 degrees Fahrenheit. In certain preferred embodiments, the fermented dairy composition can be cooled to a temperature in the range of from 35 to 80 degrees Fahrenheit, from 35 to 60 degrees Fahrenheit, even more preferably from 35 to 50 degrees Fahrenheit, and even more preferably about 40 degrees Fahrenheit.

The cooled, fermented dairy composition can be stored in tank 231, with or without agitation, at a temperature in the range of from 35 to 90 degrees Fahrenheit, preferably 35 to 60 degrees Fahrenheit, even more preferably from 35 to 50 degrees Fahrenheit, and even more preferably about 40 degrees Fahrenheit. The cooled, fermented dairy composition can be stored in tank 231 for a time period of up to 72 hours.

It is noted that, if desired, the fermented dairy composition can be cooled to a lower temperature in tank 231 of method 200 than in tank 135 of method 100, thereby inhibiting the activity of the live and active culture to a greater degree (e.g., the composition in tank 231 can be cooled to less than 65 degrees Fahrenheit if desired, whereas in contrast the composition in tank 135 can be cooled to a minimum of 65 degrees Fahrenheit). While not being bound by theory, it is believed that lower storage temperatures can be achieved in method 200 because gel-forming hydrocolloid ingredient(s) have not been combined with dairy composition prior to storage in tank 231, thereby reducing the likelihood of fouling and/or viscosity concerns of the dairy composition during such storage in tank 231.

Advantageously, because lower storage temperatures can be achieved in tank 231, thereby inhibiting the activity of the live and active culture to a greater degree, the fermented dairy composition in method 200 can generally be stored in tank 231 longer than the composition in tank 135 of method 100. Accordingly, method 200 can generally be considered more flexible at least with respect to storing the fermented dairy composition.

However it is additionally noted that including a gel-forming hydrocolloid in mixer 205, as alternatively discussed above with respect to mixer 205, could impact how low in temperature the composition could be cooled at point 230 and/or tank 231 and/or how long it could be stored in tank 231. More specifically, as discussed above with respect to mixer 205, a relatively small amount of one or more gel-forming hydrocolloid ingredient(s) could be added in mixer 205 and a relatively larger amount of one or more gel-forming hydrocolloid ingredient(s) could be added post-fermentation (e.g., via stream 234). In such an alternative method, the gel-forming hydrocolloid ingredient(s)/amount(s) combined with a dairy composition pre-fermentation (e.g., in mixer 205) could be selected such that the fermented composition could be cooled to a temperature less than 65 degrees Fahrenheit without undue fouling due to increased composition viscosity.

A fermented dairy composition can be combined with a hydrocolloid component at step 239 (see below) at a temperature in the range of from 35 to 125 degrees Fahrenheit. However, optionally and preferably, if the fermented dairy composition is cooled to a temperature in the range of from 35 to less than 80 degrees Fahrenheit, the composition can optionally be heated to facilitate the addition of the gel-forming hydrocolloid component at point 239 (see below). If the fermented dairy composition is cooled to a temperature in the range of from 80 to 90 degrees Fahrenheit the composition is not required to be heated for adding the gel-forming hydrocolloid component at point 239 (see below).

As shown in FIG. 4, if the fermented dairy composition from tank 231 is at a temperature of less than 80 degrees Fahrenheit the composition can preferably and optionally be heated at step 233 to help facilitate combining one or more gel-forming ingredients with the fermented dairy composition at point 239. In preferred embodiments, the fermented dairy composition is heated at step 233 to a temperature in the range of from 80 to 100 degrees Fahrenheit, preferably in the range of from 80 to 95 degrees Fahrenheit, and even more preferably in the range of from 80 to 90 degrees Fahrenheit.

After optional heating step 233, one or more hydrocolloid ingredients from stream 234 are combined with the fermented dairy composition at step 239.

After adding the gel-forming hydrocolloid component at step 239 but prior to filling one or more containers at step 245, the fermented dairy composition is preferably cooled at step 241 to help provide a desirable viscosity for filling. Preferably, the viscosity of the fermented dairy composition has a viscosity during filling step 245 such that the composition is fluid enough to displace the air in the container in a manner that causes the composition to be in contact with a desirable interior surface of the container. For example, referring to FIG. 2, it is preferred that the composition is in contact with the portions 26 which also function as a mold so as to shape the composition for forming a gelled composition 10 that has shaped portions 12 and 14 that correspond to the mold portions 26. In exemplary embodiments, during at least a portion of the filling step 245 the composition has a Brookfield Viscosity Value in the range of from 1000 centipoise to 17,000 centipoise, from 1500 centipoise to 15,000 centipoise, even more preferably from 2000 centipoise to 10,000 centipoise, and even more preferably a viscosity of about 7,500 centipoise at a temperature in the range of from 65 to 90 degrees Fahrenheit, preferably from 70 to 90 degrees Fahrenheit, even more preferably from 70 to 80 degrees Fahrenheit.

As shown in FIG. 4, after cooling at step 241 one or more optional additives (coloring, flavoring, combinations of these, and the like) can be added at step 240.

After filling at step 245, the filled containers can be cooled at step 250 to help cause the fermented dairy composition to gel in manner so as to provide a hand-holdable yogurt composition according to the present invention. In preferred embodiments, the composition is cooled to a temperature of about 45 degrees Fahrenheit or less, preferably to a temperature in the range of from 35 to 45 degrees Fahrenheit. The composition typically gels completely within about 48 hours depending on the particular cooling conditions.

After cooling/gelling step 250, the hand-holdable yogurt products can be packed in larger quantities at step 255, palletized at step 260, and sent to distribution centers at step 265 for distribution to, e.g., grocery stores for purchase by consumers.

A packaged, hand-holdable yogurt product according to the present invention is typically stored at refrigerator conditions so as to preserve the yogurt product during storage until it is consumed. A hand-holdable yogurt product according to the present invention can include live and active cultures so storing the product at refrigerator conditions can help to retard activity of the culture and therefore help prolong the shelf-life of the yogurt product. A packaged, hand-holdable yogurt according to the present invention can be refrigerator stable for up to about 7 weeks. As used herein, “refrigerator stable” refers to the compositions of the invention being suitable for storage at refrigeration temperatures typically of about 45° F. or less without the food composition substantially breaking down, for example, by microbial activity and/or contamination, syneresis or weeping, water accumulation, and the like, and becoming unsuitable for consumption. In turn, the shelf life of the food products described herein refers to the period of time from formulation of the food product until the time at which the food product becomes unsuitable for consumption (for any one or more of the reasons illustrated herein).

A gelled dairy composition according to the present invention (e.g., a hand-holdable yogurt product) can be marketed to one or more classes of consumers by providing the gelled composition in a package that includes labeling that indicates that the composition can be unpackaged and consumed by manipulating the composition in direct contact with one or more human hands. For example, the labeling could indicate that the composition can be played with just prior to consuming. Such a marketing strategy could advantageously target children consumers, especially since children may find a yogurt product more appealing if the product is hand-holdable such that they can hold it and play with it during the course of consumption.

### EXAMPLES

Examples 1-4 further illustrate hand-holdable, gelled dairy compositions according to the present invention. Examples 1-3 are hand-holdable, gelled yogurt compositions and Example 4 is a hand-holdable pudding composition. All percentages are based on weight.

### Example 1

The following ingredients were used to make a yogurt base:

TABLE 1.1

| Ingredient | Percentage (wt.) |
|---|---|
| Water | 66 |
| Non-fat Dried Milk | 9 |
| Cream | 5 |
| Sugar | 11 |
| High Fructose Corn Syrup | 6 |
| Starch - THERMTEX ® obtained from National | 2 |
| Starch (Bridgewater, NJ) | |
| Low Methoxyl Pectin | 0.25 |
| Potassium Sorbate | <0.05 |
| Tricalcium Phosphate | <1 |
| Vitamin A and D Blend | 0.005 |
| TOTAL | 100 |

The starch is a viscosity modifying hydrocolloid for processing. The pectin functions as a viscosity modifying hydrocolloid during processing and a gel-forming hydrocolloid. The ingredients listed in Table 1.1 were mixed together to form a yogurt base composition. The yogurt base was then homogenized and pasteurized to provide a heat-treated yogurt base. A live and active culture was added to the heat-treated base and then the composition was fermented at a temperature in the range from 109 to 115 degrees Fahrenheit to a pH of 4.55. After fermentation, the fermented composition was cooled to 40 degrees Fahrenheit. Then the composition was heated to 80 degrees Fahrenheit. After the composition was heated, a 25% gelatin hydrate was added to the fermented composition in a weight ratio of 10:90 (gelatin hydrate/fermented composition).

The gelatin hydrate was prepared by swelling 230 Bloom gelatin in cold water and then heating the gelatin/water to 158 degrees Fahrenheit to dissolve the gelatin. After dissolving, the hydrate was cooled to 140 degrees Fahrenheit for addition to the fermented composition. The gelatin functions as a gel-forming hydrocolloid and was obtained from Gelita (Brazil).

The fermented composition with gelatin was maintained at a temperature of 80 degrees Fahrenheit while being agitated. The following additives in Table 1.2 were combined with the fermented composition/gelatin blend in the following amounts:

TABLE 1.2

| Ingredient | Percentage (wt.) |
|---|---|
| Fermented Composition/Gelatin Blend | 99 |
| Citric Acid | <0.5 |
| Malic Acid | <0.5 |
| Berry Flavor | <1 |
| Blue Color | <0.1 |
| TOTAL | 100 |

The final composition was deposited at a temperature in the range of from 75 to 80 degrees Fahrenheit into molds made out of packaging film, sealed, and allowed to cool to 40 degrees Fahrenheit for complete gel set. The percentage of gelatin in the gelled composition was 2.47 weight percent based on the total weight of the gelled product. The Gel Strength Value was determined as described above. Example 1 had a Gel Strength Value of 190 grams. The Hardness was determined via the Texture Profile Analysis method described above. Example 1 had a Hardness value of 2.3 kilograms.

### Example 2

The following ingredients were used to make a yogurt base:

TABLE 2.1

| Ingredient | Percentage (wt.) |
|---|---|
| Water | 67 |
| Non-fat Dried Milk | 9 |
| Cream | 5 |
| Sugar | 16 |
| Low Acyl Gellan Gum | 0.07 |
| Starch - THERMTEX ® obtained from National | 2 |
| Starch (Bridgewater, NJ) | |
| Potassium Sorbate | <0.05 |
| Tricalcium Phosphate | <1 |
| Vitamin A and D Blend | <0.01 |
| TOTAL | 100 |

The starch is a viscosity modifying hydrocolloid for processing. The gellan gum functions as a viscosity modifying hydrocolloid during processing and a gel-forming hydrocolloid. The ingredients listed in Table 2.1 were mixed together to form a yogurt base composition. The yogurt base was then homogenized and pasteurized to provide a heat-treated yogurt base. A live and active culture was added to the heat-treated base and then the composition was fermented at a temperature in the range from 109 to 115 degrees Fahrenheit to a pH of 4.55. After fermentation, the fermented composition was cooled to 40 degrees Fahrenheit. Then the composition was heated to 80 degrees Fahrenheit. After the composition was heated, a 30% gelatin hydrate was added to the fermented composition in a weight ratio of 9.17:90.83 (gelatin hydrate/fermented composition).

The gelatin hydrate was prepared by swelling 230 Bloom gelatin in cold water and then heating the gelatin/water to 158 degrees Fahrenheit to dissolve the gelatin. After dissolving, the hydrate was cooled to 140 degrees Fahrenheit for addition to the fermented composition. The gelatin functions as a gel-forming hydrocolloid and was obtained from Gelita (Brazil).

The fermented composition with gelatin was maintained at a temperature of 80 degrees Fahrenheit while being agitated. The following additives in Table 2.2 were combined with the fermented composition/gelatin blend in the following amounts:

TABLE 2.2

| Ingredient | Percentage (wt.) |
|---|---|
| Fermented Composition/Gelatin Blend | 99 |
| Citric Acid | <0.5 |
| Malic Acid | <0.5 |
| Strawberry Flavor | <1 |
| Red Color | <0.5 |
| TOTAL | 100 |

The final composition was deposited at a temperature in the range of from 75 to 80 degrees Fahrenheit into molds made out of packaging film, sealed, and allowed to cool to 40 degrees Fahrenheit for complete gel set. The percentage of gelatin in the gelled composition was 2.72 weight percent based on the total weight of the gelled product. The Gel Strength Value was determined as described above. Example 2 had a Gel Strength Value of 195 grams. The Hardness was determined via the Texture Profile Analysis method described above. Example 2 had a Hardness value of 2.35 kilograms.

### Example 3

The following ingredients were used to make a yogurt base:

TABLE 3.1

| Ingredient | Percentage (wt.) |
|---|---|
| Water | 67 |
| Non-fat Dried Milk | 9 |
| Cream | 4 |
| Sugar | 14 |
| 230 Bloom Gelatin obtained from Gelita (Brazil) | 3 |
| Starch - THERMTEX ® obtained from National | 2 |
| Starch (Bridgewater, NJ) | |
| Potassium Sorbate | <0.1 |
| Tricalcium Phosphate | <1 |
| Vitamin A and D Blend | <0.01 |
| TOTAL | 100 |

The starch is a viscosity modifying hydrocolloid for processing. The gelatin functions as a viscosity modifying hydrocolloid during processing and a gel-forming hydrocolloid. The ingredients listed in Table 3.1 were mixed together to form a yogurt base composition. The yogurt base was then homogenized and pasteurized to provide a heat-treated yogurt base. A live and active culture was added to the heat-treated base and then the composition was fermented at a temperature in the range from 109 to 115 degrees Fahrenheit to a pH of 4.55. After fermentation, the fermented composition was cooled to 80 degrees Fahrenheit.

After the composition was cooled, the following additives in Table 3.2 were combined with the fermented composition in the following amounts:

TABLE 3.2

| Ingredient | Percentage (wt.) |
|---|---|
| Fermented Composition/Gelatin Blend | 99 |
| Citric Acid | <0.5 |
| Malic Acid | <0.5 |
| Strawberry Flavor | <1 |
| Red Color | <0.5 |
| TOTAL | 100 |

The final composition was deposited at a temperature in the range of from 75 to 80 degrees Fahrenheit into molds made out of packaging film, sealed, and allowed to cool to 40 degrees Fahrenheit for complete gel set. The percentage of gelatin in the gelled composition was 2.97 weight percent based on the total weight of the gelled product. The Gel Strength Value was determined as described above. Example 3 had a Gel Strength Value of 244 grams. The Hardness was determined via the Texture Profile Analysis method described above. Example 3 had a Hardness value of 3.76 kilograms.

### Example 4

The following ingredients were used to make a pudding base:

TABLE 4.1

| Ingredient | Percentage (wt.) |
|---|---|
| Whole Milk | 65 |
| Water | 16 |
| Sugar | 13 |
| Starch - THERMTEX ® obtained from National | 3 |
| Starch (Bridgewater, NJ) | |
| Salt | 2 |
| Sodium stearoyl lactilate | <0.5 |
| Disodium phosphate | <0.5 |
| Vanilla flavoring | <1 |
| TOTAL | 100 |

The starch is a viscosity modifying hydrocolloid for processing. The ingredients listed in Table 4.1 were mixed together to form a pudding base composition. The pudding base was then homogenized and pasteurized to provide a heat-treated pudding base. The pudding base was cooled to 40 degrees Fahrenheit. Then the composition was heated to 80 degrees Fahrenheit. After the composition was heated, a 30% gelatin hydrate was added to the pudding base under constant swept surface agitation and in a weight ratio of 10:90 (gelatin hydrate/pudding base).

The gelatin hydrate was prepared by swelling 230 Bloom gelatin in cold water and then heating the gelatin/water to 158 degrees Fahrenheit to dissolve the gelatin. After dissolving, the hydrate was cooled to 140 degrees Fahrenheit for addition to the pudding base. The gelatin functions as a gel-forming hydrocolloid and was obtained from Gelita (Brazil).

The final composition was deposited at a temperature in the range of from 75 to 80 degrees Fahrenheit into molds made out of packaging film, sealed, and allowed to cool to 40 degrees Fahrenheit for complete gel set. The percentage of gelatin in the gelled composition was 3 weight percent based on the total weight of the gelled product. The Gel Strength Value was determined as described above. Example 4 had a Gel Strength Value of 196 grams.

Other embodiments of this invention will be apparent to those skilled in the art upon consideration of this specification and/or practice of the invention disclosed herein. All patents, patent documents, and publications cited herein are hereby incorporated by reference in their respective entirety.

1. A hand-holdable, fermented gelled dairy composition comprising:
a) a live and active culture; and
b) at least one gel-forming hydrocolloid ingredient, wherein the hydrocolloid ingredient is present in an amount such that the gelled dairy composition has a Gel Strength Value of at least 100 grams.

2. The composition of claim 1, wherein the composition has a Gel Strength Value of at least 110 grams.

3. The composition of claim 1, wherein the at least one gel-forming hydrocolloid ingredient is selected from the group consisting of gelatin, agar, alginate, carrageenan, pectin, starch, xanthan/locust bean gum blend, gellan gum, konjac gum, and combinations thereof.

4. The composition of claim 1, wherein the fermented dairy composition is yogurt.

5. A hand-holdable, gelled dairy composition comprising at least one gel-forming hydrocolloid ingredient, wherein the hydrocolloid ingredient is present in an amount such that the gelled dairy composition has a Gel Strength Value in the range of from 110 to 800 grams.

6. The composition of claim 5, wherein the composition has a Gel Strength Value in the range of from 110 to 500 grams.

7. The composition of 5, wherein the composition has a Gel Strength Value in the range of from 115 to 375 grams.

8. The composition of claim 5, wherein the composition has a Gel Strength Value in the range of from 120 to 275 grams.

9. The composition of claim 5, wherein the at least one gel-forming hydrocolloid ingredient comprises gelatin that is present in an amount of at least 1.4 percent by weight based on the total weight of the hand-holdable, gelled, fermented dairy composition.

10. A hand-holdable, gelled dairy composition comprising:
a) at least one gel-forming hydrocolloid ingredient, wherein the at least one gel-forming hydrocolloid ingredient comprises gelatin that is present in an amount of at least 1.4 percent by weight based on the total weight of the hand-holdable, gelled dairy composition; and
b) water present in an amount in the range of from 65 to 85 percent by weight based on the total weight of the hand-holdable, gelled, dairy composition.

11. The composition of claim 10, wherein the gelatin is present in an amount of at least 1.5 percent by weight based on the total weight of the gelled dairy composition.

12. The composition of claim 10, wherein the gelatin is present in an amount of at least 2.0 percent by weight based on the total weight of the gelled dairy composition.

13. The composition of claim 10, wherein the gelatin is present in an amount in the range of from 1.75 to 10 percent by weight based on the total weight of the gelled dairy composition.

14. The composition of claim 10, wherein the gelatin is present in an amount in the range of from 1.75 to 4 percent by weight based on the total weight of the gelled dairy composition.

15. The composition of claim 10, wherein the gelatin is present in an amount in the range of from 2 to 3.5 percent by weight based on the total weight of the gelled dairy composition.

16. The composition of claim 10, wherein the water is present in an amount in the range of from 70 to 80 percent by weight based on the total weight of the hand-holdable, gelled, dairy composition.

17. The composition of claim 10, wherein the water is present in an amount in the range of from 70 to 75 percent by weight based on the total weight of the hand-holdable, gelled, dairy composition.

18. The composition of claim 10, further comprising fat wherein the fat is present in an amount in the range of from 0.5 to 10 percent by weight based on the total weight of the hand-holdable, gelled, dairy composition.

19. The composition of claim 10, further comprising fat wherein the fat is present in an amount in the range of from 0.5 to 5 percent by weight based on the total weight of the hand-holdable, gelled, dairy composition.

20. A hand-holdable, gelled dairy composition comprising a non-dairy, gel-forming hydrocolloid component comprising:
a) a first, non-dairy, gel-forming hydrocolloid ingredient; and
b) a second, non-dairy, gel-forming hydrocolloid ingredient,
wherein the total amount of the first and second hydrocolloid ingredients is such that the gelled dairy composition has a Gel Strength Value of at least 100 grams.

21. The composition of claim 20, wherein the first hydrocolloid ingredient comprises an elastic, non-dairy, gel-forming hydrocolloid ingredient and the second hydrocolloid ingredient comprises a brittle, non-dairy, gel-forming hydrocolloid ingredient.

22. The composition of claim 21, wherein the elastic hydrocolloid ingredient is selected from the group consisting of gelatin, high mannuronic acid alginate, iota carrageenan, high acyl gellan, and combinations thereof.

23. The composition of claim 21, wherein the brittle hydrocolloid ingredient is selected from the group consisting of agar, high guluronic acid alginate, kappa carrageenan, low acyl gellan gum, and pectin, starch, and combinations thereof.

24. The composition of claim 20, wherein the composition has a Gel Strength Value in the range of from 115 to 375 grams.

25. The composition of claim 20, wherein the composition has a Gel Strength Value in the range of from 120 to 275 grams.

26. The composition of claim 20, wherein the composition is in the form of a three-dimensional shape having one or more contours that form the shape of an animal shape, a cartoon character shape, and combinations thereof.

27. The composition of claim 26, wherein the composition is packaged in a container comprising a film having a surface that conforms to and is in contact with the contours of the composition.

28. The composition of claim 27, wherein at least the portion of the film in contact with the composition comprises a release agent.

29. The composition of claim 28, wherein the release agent comprises glycerol monostearate.

30. The composition of claim 20, wherein the dairy composition is a fermented dairy composition.

31-39. (canceled)

40. A method of making a hand-holdable, gelled, fermented dairy composition comprising the steps of:
a) providing a fermentable dairy base composition;
b) fermenting the dairy base composition to provide a fermented dairy composition, wherein the temperature of the composition during fermentation is 125 degrees Fahrenheit or less;
c) combining the fermented dairy composition with a non-dairy, gel-forming hydrocolloid component, wherein the hydrocolloid component comprises:
i) a first, non-dairy, gel-forming hydrocolloid ingredient; and
ii) a second, non-dairy, gel-forming hydrocolloid ingredient; and
d) causing the fermented dairy composition to gel in a manner to provide a hand-holdable, gelled, fermented dairy composition having a Gel Strength Value of at least 100 grams.

41. The method of claim 40, wherein from during the fermentation step to the end of the step of causing the fermented composition to gel, the fermented composition is not exposed to a temperature of greater than 125 degrees Fahrenheit.

42. The method of claim 40, further comprising the step of, prior to the combining step, cooling the fermented dairy composition to a temperature of less than 80 degrees Fahrenheit.

43. The method of claim 42, wherein the cooled composition is maintained at a temperature of less than 80 degrees Fahrenheit for a time period of up to 72 hours.

44. The method of claim 42, further comprising the step of, after the cooling step and prior to the combining step, heating the fermented dairy composition so that the composition is at a temperature in the range of from 80 to 125 degrees Fahrenheit while the non-dairy, gel-forming hydrocolloid component is being combined with the fermented dairy composition.

45. The method of claim 40, wherein the hand-holdable, gelled, fermented dairy composition is a yogurt.

46. A method of making a hand-holdable, gelled dairy composition comprising the step of causing the dairy composition to gel in a manner to provide a hand-holdable, gelled, dairy composition having a Gel Strength Value in the range of from 110 to 800 grams.

47. The method of claim 46, wherein the at least one non-dairy, gel-forming hydrocolloid ingredient comprises gelatin that is present in an amount of at least 1.4 percent by weight based on the total weight of the gelled dairy composition.

48. The method of claim 46, further comprising the steps of
a) prior to the step of causing the composition to gel, filling one or more containers with the dairy composition; and
b) prior to the step of filling, causing the dairy composition to have a temperature of 125 degrees Fahrenheit or less so that the dairy composition has a temperature of 125 degrees Fahrenheit or less during the entire filling step.
